(19) United States
(12) Patent Application Publication
(10) Pub. No.: US 2026/0327759 A1
(43) Pub. Date: Oct. 22, 2026

(54) HIGH-STRENGTH STEEL SHEET AND METHOD FOR PRODUCING SAME, AND MEMBER AND METHOD FOR PRODUCING SAME

(71) Applicant: JFE Steel Corporation, Chiyoda-ku, Tokyo (JP)

(72) Inventors: Lingling YANG, Chiyoda-ku, Tokyo (JP); Yuki TOJI, Chiyoda-ku, Tokyo (JP); Yuji TANAKA, Chiyoda-ku, Tokyo (JP); Yasuhiro NAGAOKA, Chiyoda-ku, Tokyo (JP)

(73) Assignee: JFE Steel Corporation, Chiyoda-ku, Tokyo (JP)

(21) Appl. No.: 19/105,917

(22) PCT Filed: Jul. 25, 2023
(86) PCT No.: PCT/JP2023/027165

§ 371 Date: Feb. 24, 2025

(30) Foreign Application Priority Data
Aug. 29, 2022 (JP) 2022-135672

(51) Int. Cl. C22C 38/04; B32B 15/01; C21D 6/00; C21D 8/0221; C21D 8/0247; C21D 8/0278; C21D 9/46; C22C 38/00; C22C 38/02; C22C 38/06; C22C 38/08; C22C 38/10; C22C 38/12; C22C 38/14; C22C 38/16; C22C 38/38; C22C 38/60

(52) U.S. Cl. CPC C22C 38/04; B32B 15/013; C21D 6/001; C21D 6/002; C21D 6/005; C21D 6/007; C21D 6/008; C21D 8/0226; C21D 8/0236; C21D 8/0263; C21D 8/0278; C21D 9/46; C22C 38/001; C22C 38/002; C22C 38/005; C22C 38/008; C22C 38/02; C22C 38/06; C22C 38/08; C22C 38/10; C22C 38/12; C22C 38/14; C22C 38/16; C22C 38/38; C22C 38/60; C21D 2211/001; C21D 2211/002; C21D 2211/008

(57) ABSTRACT

A high strength steel sheet having a yield strength of not less than 800 MPa is disclosed. The chemical composition includes, by mass: C in an amount of 0.150 to 0.500%, Si in an amount of 0.01 to 3.00%, Mn in an amount of 1.50 to 4.00%, P in an amount of not more than 0.100%, S in an amount of not more than 0.0200%, Al in an amount of not more than 0.100%, N in an amount of not more than 0.0100%, and O in an amount of not more than 0.0100%, with a balance being Fe and inevitable impurities. A total area fraction of tempered martensite and bainite is 55% to 95%, an average grain size of retained austenite is not more than 5.0 μm, and an area fraction of a structure S₁ having a certain carbon concentration is not less than 50.0%.

### CROSS REFERENCE TO RELATED APPLICATIONS

This is the U.S. National Phase application of PCT/JP2023/027165, filed Jul. 25, 2023, which claims priority to Japanese Patent Application No. 2022-135672, filed Aug. 29, 2022, the disclosures of these applications being incorporated herein by reference in their entireties for all purposes.

### FIELD OF THE INVENTION

The invention relates to a high strength steel sheet having a yield strength (YS) of not less than 800 MPa and a method of producing the same as well as a member and a method of producing the same.

### BACKGROUND OF THE INVENTION

In recent years, in the automotive industry for example, an improvement in the fuel efficiency of automobiles has been hoped for to reduce the carbon dioxide gas (CO₂) emission from a viewpoint of the preservation of the global environment.

In order to improve the fuel efficiency of automobiles, it is effective to reduce the vehicle body weight, and in this case, it is necessary to reduce the vehicle body weight while maintaining the strength of the vehicle body. If the number of automotive parts can be reduced by strengthening a steel sheet which becomes the parts and simplifying the structure of the vehicle body, reduction of the vehicle body weight can be achieved.

For example, Patent Literatures 1 to 3 each disclose a high strength steel sheet having a yield strength of not less than 800 MPa.

### PATENT LITERATURE

Patent Literature 1: JP 2018-21231 A
Patent Literature 2: JP 2018-21233 A
Patent Literature 3: JP 2017-214647 A

### SUMMARY OF THE INVENTION

A high strength steel sheet having a yield strength of not less than 800 MPa usually improves processability due to a transformation induced plasticity (TRIP) effect of retained austenite.

In other words, retained austenite is transformed into martensite due to the TRIP effect during processing to enhance the strength and increase the strain dispersibility, thereby improving the ductility.

However, when such a steel sheet is formed into automotive parts, retained austenite is transformed into hard martensite, and this transformation sometimes degrades the fracture resistance at a collision (hereinafter, also simply referred to as “fracture resistance”).

Further, a steel sheet used as automotive parts is also required to be excellent in terms of proof stress at a collision (hereinafter, referred to as “collision proof stress”).

Therefore, aspects of the present invention aim at providing a high strength steel sheet having a yield strength of not less than 800 MPa and also having excellent collision proof stress and fracture resistance.

The present inventors found that employing the configuration described below enables the achievement of the above-mentioned object. Aspects of the present invention have been thus completed.

Specifically, aspects of the present invention include the following [1] to [10].

[1]A high strength steel sheet comprising a steel sheet,
wherein an amount of diffusible hydrogen in steel of the steel sheet is not more than 0.50 mass ppm,
the steel sheet has chemical composition and microstructure,
the chemical composition including, by mass:
C in an amount of 0.150 to 0.500%,
Si in an amount of 0.01 to 3.00%,
Mn in an amount of 1.50 to 4.00%,
P in an amount of not more than 0.100%,
S in an amount of not more than 0.0200%,
Al in an amount of not more than 0.100%,
N in an amount of not more than 0.0100%, and
O in an amount of not more than 0.0100%, with a balance being Fe and inevitable impurities,
in the microstructure,
a total area fraction of tempered martensite and bainite is 55% to 95%,
an average grain size of retained austenite is not more than 5.0 μm, and
an area fraction of a structure S₁ having a carbon concentration of more than 0.1 mass % and not more than 0.3 mass % is not less than 50.0%, and an area fraction of a structure S₂ having a carbon concentration of not more than 0.5 mass % is not more than 10.0%.
   [2] The high strength steel sheet according to [1] above, wherein the chemical composition further includes at least one element selected from the group consisting of: by mass,
B in an amount of not more than 0.0100%,
Ti in an amount of not more than 0.200%,
Nb in an amount of not more than 0.200%,
V in an amount of not more than 0.200%,
W in an amount of not more than 0.100%,
Mo in an amount of not more than 1.000%,
Cr in an amount of not more than 1.000%,
Sb in an amount of not more than 0.200%,
Sn in an amount of not more than 0.200%,
Zr in an amount of not more than 0.1000%,
Te in an amount of not more than 0.100%,
Cu in an amount of not more than 1.000%,
Ni in an amount of not more than 1.000%,
Ca in an amount of not more than 0.0100%,
Mg in an amount of not more than 0.0100%,
REM in an amount of not more than 0.0100%,
Co in an amount of not more than 0.010%,
Ta in an amount of not more than 0.10%,
Hf in an amount of not more than 0.10%, and
Bi: in an amount of not more than 0.200%.
   [3] The high strength steel sheet according to [1] or [2] above, wherein a plating layer is further provided on a surface of the steel sheet.
   [4] The high strength steel sheet according to [3] above, wherein the plating layer is a galvanizing layer, a galvannealing layer or an electrogalvanizing layer.
   [5]A method of producing the high strength steel sheet according to [1] above, the method comprising:
subjecting a steel slab having the chemical composition according to [1] above to hot rolling to obtain a hot rolled steel sheet;
subjecting the hot rolled steel sheet to cold rolling to obtain a cold rolled steel sheet; and
heating the cold rolled steel sheet at a heating temperature T1 of 750° C. to 950° C. for 10 s to 500 s, cooling the heated cold rolled steel sheet to a cooling stop temperature T2 of not lower than 120° C. and lower than 280° C., re-heating the cooled cold rolled steel sheet to a re-heating temperature T3 of 280 to 400° C., and re-cooling the re-heated cold rolled steel sheet without retaining the re-heated cold rolled steel sheet at the re-heating temperature T3,
wherein a heat effect index P from the re-heating temperature T3 to (T3−30°) C is 4000 to 6200, the heat effect index P being expressed by Formula (1),

P=T3(log(5t)+12) (1)

in Formula (1), t is a cooling time from the re-heating temperature T3 to (T3−30°) C, and a unit thereof is second. [6]A method of producing the high strength steel sheet according to [2] above, the method comprising:
subjecting a steel slab having the chemical composition according to [2] above to hot rolling to obtain a hot rolled steel sheet;
subjecting the hot rolled steel sheet to cold rolling to obtain a cold rolled steel sheet; and heating the cold rolled steel sheet at a heating temperature T1 of 750° C. to 950° C. for 10 s to 500 s, cooling the heated cold rolled steel sheet to a cooling stop temperature T2 of not lower than 120° C. and lower than 280° C., re-heating the cooled cold rolled steel sheet to a re-heating temperature T3 of 280 to 400° C., and re-cooling the re-heated cold rolled steel sheet without retaining the re-heated cold rolled steel sheet at the re-heating temperature T3, wherein a heat effect index P from the re-heating temperature T3 to (T3−30°) C is 4000 to 6200, the heat effect index P being expressed by the Formula (1),

P=T3(log(5t)+12) (1)
in Formula (1), t is a cooling time from the re-heating temperature T3 to (T3−30°) C, and a unit thereof is second. [7] The method of producing the high strength steel sheet according to [5] or [6] above, wherein the cold rolled steel sheet is subjected to a plating treatment.
   [8] The method of producing the high strength steel sheet according to [7] above, wherein the plating treatment is a galvanizing treatment, a galvannealing treatment, or an electrogalvanizing treatment.
   [9]A member obtained by using the high strength steel sheet according to any one of [1] to [4] above.
   [10]A method of producing a member, the method comprising subjecting the high strength steel sheet according to any one of [1] to [4] above to at least one of a forming process and a joining process to obtain a member.

According to aspects of the present invention, there can be provided a high strength steel sheet having a yield strength of not less than 800 MPa and also having excellent collision proof stress and fracture resistance.

### BRIEF DESCRIPTION OF THE DRAWINGS

FIG. 1 is a chart diagram showing one example of a heat treatment.

FIG. 2A is a cross-sectional view showing a hat member.

FIG. 2B is a schematic view showing the hat member subjected to a three-point bending test.

### DETAILED DESCRIPTION OF EMBODIMENTS OF THE INVENTION

### [High Strength Steel Sheet]

A high strength steel sheet of the present embodiment (hereinafter also referred to as the “present high strength steel sheet”) includes a steel sheet, and may further include a plating layer on a surface of the steel sheet as described later.

The steel sheet included in the present high strength steel sheet has chemical composition and microstructure which are to be described later, and satisfies an amount of diffusible hydrogen in steel to be described later.

The term “high strength” means having a yield strength (YS) of not less than 800 MPa.

The present high strength steel sheet has a yield strength of not less than 800 MPa and also has excellent collision proof stress and fracture resistance. Therefore, since the strength against a collision is sufficient, the steel sheet is preferably used as parts of transportation machines such as automobiles.

As a method of forming the present high strength steel sheet, a general processing method such as press working can be used without limitation. As a method of welding the present high strength steel sheet, a general welding method such as spot welding or arc welding can be used without limitation.

### <Steel Sheet>

First, the steel sheet included in the present high strength steel sheet is described.

The thickness of the steel sheet is not particularly limited and is, for example, not less than 0.5 mm and not more than 3.0 mm.

### <<Chemical Composition>>

Chemical composition of the steel sheet included in the present high strength steel sheet (hereinafter, conveniently referred to as “present chemical composition”) is described.

The percentage “%” used in the present chemical composition means “mass %” unless otherwise noted.

### (C: 0.150 to 0.500%)

C generates martensite to raise the strength of the steel sheet. When an amount of C is too small, the total area fraction of tempered martensite and bainite decreases, whereby the collision proof stress and the yield strength deteriorate. Hence, the amount of C is not less than 0.150%, preferably not less than 0.180%, and more preferably not less than 0.200%.

On the other hand, when the amount of C is too large, a structure (structure S₂) having a high carbon concentration increases and becomes a starting point of cracking at a collision, whereby the fracture resistance deteriorates. Hence, the amount of C is not more than 0.500%, preferably not more than 0.460%, and more preferably not more than 0.400%.

### (Si: 0.01 to 3.00%)

Si suppresses generation of carbides during a heat treatment and increases the yield strength. From the viewpoint of obtaining a good collision proof stress and the yield strength of not less than 800 MPa, an amount of Si is not less than 0.01%, preferably not less than 0.50%, and more preferably not less than 0.80%.

On the other hand, when the amount of Si is too large, a carbon concentration in the retained austenite excessively increases, and a hard structure (structure S₂) having a high carbon concentration increases and becomes a starting point of cracking at a collision, whereby the fracture resistance deteriorates. Hence, the amount of Si is not more than 3.00%, preferably not more than 2.60%, and more preferably not more than 2.40%.

### (Mn: 1.50 to 4.00%)

Mn influences the area fraction of tempered martensite and bainite. From the viewpoint of obtaining a good collision proof stress and the yield strength of not less than 800 MPa, an amount of Mn is not less than 1.50%, preferably not less than 1.90%, and more preferably not less than 2.30%.

On the other hand, when the amount of Mn is too large, hard tempered martensite and bainite excessively increase, whereby the fracture resistance at a collision deteriorates. Hence, the amount of Mn is not more than 4.00%, preferably not more than 3.50%, and more preferably not more than 3.30%.

(P: Not more than 0.100%)

P is segregated in a prior austenite grain boundary to embrittle the grain boundary, whereby the fracture resistance at a collision deteriorates. Accordingly, an amount of P is not more than 0.100%, preferably not more than 0.030%, and more preferably not more than 0.010%.

While the lower limit of the amount of P is not particularly limited, since P is a solid-solution strengthening element and increases the strength of the steel sheet, the amount of P is preferably 0.001%, more preferably 0.002%, and further preferably 0.003%.

(S: Not more than 0.0200%)

S combines with Mn to form coarse MnS, and the MnS becomes a starting point of cracking at a collision, whereby the fracture resistance at a collision deteriorates. Hence, an amount of S is not more than 0.0200%, preferably not more than 0.0100%, and more preferably not more than 0.0020%.

The lower limit of the amount of S is not particularly limited and is preferably 0.0001%, more preferably 0.0002%, and further preferably 0.0003% due to the production engineering restrictions.

(Al: Not more than 0.100%)

Al acts as a deoxidizer. When an amount of Al is too large, an oxide and a nitride aggregate and coarsen to become a starting point of cracking at a collision, whereby the fracture resistance at a collision deteriorates. Hence, an amount of Al is not more than 0.100%, preferably not more than 0.080%, and more preferably not more than 0.060%.

The lower limit of the amount of Al is not particularly limited and is, for example, 0.010% and preferably 0.020% because generation of carbides during the heat treatment is suppressed and generation of retained austenite is promoted.

(N: Not more than 0.0100%)

N combines with Ti to form TiN. When an amount of N is too large, an amount of TiN to be formed increases, and therefore, the TiN becomes a starting point of cracking at a collision, whereby the fracture resistance at a collision deteriorates. Hence, the amount of N is not more than 0.0100%, preferably not more than 0.0080%, and more preferably not more than 0.0060%.

The lower limit of the amount of N is not particularly limited and is preferably 0.0001%, more preferably 0.0003%, and further preferably 0.0005% due to the production engineering restrictions.

(O: Not More than 0.0100%)

O forms an oxide, and the formed oxide becomes a starting point of cracking at a collision, whereby the fracture resistance at a collision deteriorates. Accordingly, an amount of O is not more than 0.0100%, preferably not more than 0.0050%, and more preferably not more than 0.0020%.

### (Other Elements)

The present chemical composition may further include at least one element selected from the group consisting of elements described below, in percentage by mass.

((B: Not More than 0.0100%))

B is preferably added because it is an element capable of improving the hardenability of the steel sheet by being segregated in an austenite grain boundary and increases the yield strength of the steel sheet.

Meanwhile, when the amount of B is too large, Fe₂₃(CB)₆ is formed and becomes a starting point of cracking at a collision, whereby the fracture resistance at a collision deteriorates. Hence, an amount of B is preferably not more than 0.0100%, preferably not more than 0.0050%, more preferably not more than 0.0040%, and particularly preferably not more than 0.0030%.

The lower limit of the amount of B is not particularly limited and is, for example, 0.0005% and preferably 0.0010% from the viewpoint of obtaining the effect of addition of B.

((Ti: Not More than 0.200%))

Ti is preferably added because it forms fine carbides, nitrides or carbonitrides during hot rolling or a heat treatment to thereby increase the yield strength of the steel sheet.

Meanwhile, when an amount of Ti is too large, Ti combines with N to form coarse nitrides, whereby the fracture resistance at a collision deteriorates. Accordingly, the amount of Ti is preferably not more than 0.200%, more preferably not more than 0.100%, and further preferably not more than 0.050%.

The lower limit of the amount of Ti is not particularly limited and is, for example, 0.005%, and preferably 0.010% from the viewpoint of obtaining the effect of addition of Ti.

((Nb: Not More than 0.200%, V: Not More than 0.200%, W: Not More than 0.100%))

Nb, V and W are preferably added because each of them forms fine carbides, nitrides or carbonitrides during hot rolling or a heat treatment to thereby increase the yield strength of the steel sheet.

Meanwhile, when an addition amount is excessively large, these elements do not dissolve during slab heating and remain as coarse carbides. The coarse carbides become starting points of cracking at a collision, whereby the fracture resistance at a collision deteriorates.

Accordingly, an amount of Nb is preferably not more than 0.200%, more preferably not more than 0.100%, and further preferably not more than 0.050%. The lower limit thereof is not particularly limited and is, for example, 0.005% and is preferably 0.010% from the viewpoint of obtaining the effect of addition of Nb.

An amount of V is preferably not more than 0.200%, more preferably not more than 0.100%, and further preferably not more than 0.050%. The lower limit thereof is not particularly limited and is, for example, 0.005% and preferably 0.010% from the viewpoint of obtaining the effect of addition of V.

An amount of W is preferably not more than 0.100%, more preferably not more than 0.080%, and further preferably not more than 0.050%. The lower limit thereof is not particularly limited and is, for example, 0.010% and preferably 0.020% from the viewpoint of obtaining the effect of addition of W.

((Mo: Not More than 1.000%, Cr: Not More than 1.000%))

Mo and Cr are preferably added because they increase the hardenability of the steel sheet to thereby increase the yield strength of the steel sheet. Meanwhile, when an amount of each of these elements is excessively large, hard martensite is excessively generated, whereby the fracture resistance at a collision deteriorates.

Accordingly, an amount of Mo is preferably not more than 1.000%, more preferably not more than 0.800%, and further preferably not more than 0.500%. The lower limit thereof is not particularly limited and is, for example, 0.010% and preferably 0.020% from the viewpoint of obtaining the effect of addition of Mo.

An amount of Cr is preferably not more than 1.000%, more preferably not more than 0.800%, and further preferably not more than 0.500%. The lower limit thereof is not particularly limited and is, for example, 0.010% and preferably 0.020% from the viewpoint of obtaining the effect of addition of Cr.

((Sb: Not More than 0.200%, Sn: Not More than 0.200%))

Sb and Sn are preferably added because each of them suppresses decarburization of the surfaces of the steel sheet to thereby increase the yield strength of the steel sheet. Meanwhile, when an amount of each of these elements is excessively large, the steel is embrittled, whereby the fracture resistance at a collision deteriorates.

Hence, an amount of Sb is preferably not more than 0.200%, more preferably not more than 0.080%, and further preferably not more than 0.040%. The lower limit thereof is not particularly limited and is, for example, 0.001% and preferably 0.002% from the viewpoint of obtaining the effect of addition of Sb.

An amount of Sn is preferably not more than 0.200%, more preferably not more than 0.080%, and further preferably not more than 0.040%. The lower limit thereof is not particularly limited and is, for example, 0.001% and preferably 0.002% from the viewpoint of obtaining the effect of addition of Sn.

((Zr: Not More than 0.1000%, Te: Not More than 0.100%))

Zr and Te are preferably added because each of them spheroidizes the shapes of nitrides and sulfides to thereby improve the fracture resistance at a collision. Meanwhile, when an amount of each of these elements is excessively large, they increase coarse precipitates remaining in an undissolved state during steel slab heating, whereby the fracture resistance at a collision deteriorates.

Hence, an amount of Zr is preferably not more than 0.1000%, more preferably not more than 0.0800%, and further preferably not more than 0.0500%. The lower limit thereof is not particularly limited and is, for example, 0.0050% and preferably 0.0100% from the viewpoint of obtaining the effect of addition of Zr.

An amount of Te is preferably not more than 0.100%, more preferably not more than 0.080%, and further preferably not more than 0.050%. The lower limit thereof is not particularly limited and is, for example, 0.005% and preferably 0.010% from the viewpoint of obtaining the effect of addition of Te.

((Cu: Not More than 1.000%))

Cu is preferably added because it increases the hardenability of the steel sheet to thereby increase the yield strength of the steel sheet. Meanwhile, when an amount of Cu is excessively large, the fracture resistance at a collision deteriorates due to an increase of Cu inclusions.

Hence, an amount of Cu is preferably not more than 1.000%, more preferably not more than 0.800%, and further preferably not more than 0.500%. The lower limit thereof is not particularly limited and is, for example, 0.010% and preferably 0.020% from the viewpoint of obtaining the effect of addition of Cu.

((Ni: Not More than 1.000%))

Ni is preferably added because it increases the hardenability of the steel sheet to thereby increase the yield strength of the steel sheet. Meanwhile, when an amount of Ni is excessively large, the fracture resistance at a collision deteriorates due to an increase of hard martensite.

Hence, an amount of Ni is preferably not more than 1.000%, more preferably not more than 0.800%, and further preferably not more than 0.500%. The lower limit thereof is not particularly limited and is, for example, 0.010% and preferably 0.020% from the viewpoint of obtaining the effect of addition of Ni.

((Ca: Not More than 0.0100%, Mg: Not More than 0.0100%, REM: Not More than 0.0100%))

Ca, Mg and REM (Rare Earth Metal) are preferably added because they spheroidize the shapes of precipitates such as sulfides and oxides to thereby increase the fracture resistance at a collision. Meanwhile, when an amount of each of these elements is excessively large, coarse sulfides become starting points of cracking at a collision, whereby the fracture resistance at a collision deteriorates.

Hence, an amount of Ca is preferably not more than 0.0100%, more preferably not more than 0.0050%, and further preferably not more than 0.0040%. The lower limit thereof is not particularly limited and is, for example, 0.0005% and preferably 0.0010% from the viewpoint of obtaining the effect of addition of Ca.

An amount of Mg is preferably not more than 0.0100%, more preferably not more than 0.0050%, and further preferably not more than 0.0040%. The lower limit thereof is not particularly limited and is, for example, 0.0005% and preferably 0.0010% from the viewpoint of obtaining the effect of addition of Mg.

An amount of REM is preferably not more than 0.0100%, more preferably not more than 0.0040%, and further preferably not more than 0.0030%. The lower limit thereof is not particularly limited and is, for example, 0.0005% and preferably 0.0010% from the viewpoint of obtaining the effect of addition of REM.

((Co: Not More than 0.010%, Ta: Not More than 0.10%, Hf: Not More than 0.10%, Bi: Not More than 0.200%))

Co, Ta, Hf and Bi are preferably added because they spheroidize the shapes of precipitates to thereby increase the fracture resistance at a collision. Meanwhile, when an amount of each of these elements is excessively large, coarse precipitates become starting points of cracking at a collision, and the fracture resistance at a collision deteriorates.

Hence, an amount of Co is preferably not more than 0.010%, more preferably not more than 0.008%, and further preferably not more than 0.007%. The lower limit thereof is not particularly limited and is, for example, 0.001% and preferably 0.002% from the viewpoint of obtaining the effect of addition of Co.

An amount of Ta is preferably not more than 0.10%, more preferably not more than 0.08%, and further preferably not more than 0.07%. The lower limit thereof is not particularly limited and is, for example, 0.01% and preferably 0.02% from the viewpoint of obtaining the effect of addition of Ta.

An amount of Hf is preferably not more than 0.10%, more preferably not more than 0.08%, and further preferably not more than 0.07%. The lower limit thereof is not particularly limited and is, for example, 0.01% and preferably 0.02% from the viewpoint of obtaining the effect of addition of Hf.

An amount of Bi is preferably not more than 0.200%, more preferably not more than 0.100%, and further preferably not more than 0.080%. The lower limit thereof is not particularly limited and is, for example, 0.001% and preferably 0.005% from the viewpoint of obtaining the effect of addition of REM.

### (Balance)

The balance in the present chemical composition consists of Fe and inevitable impurities.

### <<Microstructure>>

Next, a microstructure of the steel sheet included in the present high strength steel sheet (hereinafter, conveniently referred to as “present microstructure”) is described.

In order to obtain the effect according to aspects of the present invention, it is not enough to satisfy the present chemical composition alone, and it is necessary to satisfy the present microstructure described below.

Hereinbelow, the area fraction is an area fraction with respect to the entire microstructure. The area fraction of each structure is determined by a method described in Examples below.

### (Total Area Fraction of Tempered Martensite and Bainite: 55% to 95%)

From the viewpoint of stably securing good collision proof stress and yield strength, the total area fraction of tempered martensite and bainite is not less than 55%, preferably not less than 58%, and more preferably not less than 60%.

On the other hand, when the total area fraction of tempered martensite and bainite is too high, the hard structure (structure S₂) having a high carbon concentration increases and becomes a starting point of cracking at a collision, whereby the fracture resistance deteriorates. Accordingly, this total area fraction is not more than 95%, preferably not more than 92%, and more preferably not more than 88%.

(Average Grain Size of Retained Austenite: Not More than 5.0 μm)

When a stress is repeatedly applied to the steel sheet, retained austenite is transformed into hard martensite by work hardening. When the retained austenite is too large, the martensite transformed from the retained austenite becomes a starting point of cracking at a collision, whereby the fracture resistance deteriorates.

Accordingly, the average grain size of retained austenite is not more than 5.0 μm, preferably not more than 4.0 μm, more preferably not more than 3.0 μm, further preferably not more than 2.0 μm, and particularly preferably not more than 1.0 μm.

(Area Fraction of Structure S₁: Not Less than 50.0%)

A structure having a low carbon concentration has high toughness and high fracture resistance. In addition, the structure having a low carbon concentration includes at least part of retained austenite. The retained austenite having a low carbon concentration is liable to undergo martensitic transformation. When a stress is repeatedly applied to the steel sheet, the retained austenite having a low carbon concentration undergoes martensitic transformation, so that strain at a collision is largely dispersed, and occurrence of cracks at a collision can be suppressed. In other words, the fracture resistance is improved.

Hence, the area fraction of a structure S₁ having a carbon concentration of more than 0.1 mass % and not more than 0.3 mass % is not less than 50.0%, preferably not less than 55.0%, and more preferably not less than 60.0%.

Meanwhile, the upper limit of the area fraction of the structure S₁ is not particularly limited and is, for instance, 90.0% and preferably 95.0%.

(Area Fraction of Structure S₂: Not More than 10.0%)

Since a structure having a high carbon concentration is hard, it becomes a starting point of cracking at a collision, whereby the fracture resistance deteriorates.

Hence, the area fraction of the structure S₂ having a carbon concentration of not less than 0.5 mass % is not more than 10.0%, preferably not more than 8.0%, and more preferably not more than 7.0%.

### (Remaining Structure)

The present microstructure may include a structure (remaining structure) other than tempered martensite, bainite and retained austenite.

Examples of the remaining structure include known structures such as fresh martensite; pearlite; ferrite; iron-based carbonitride; alloyed carbonitride; and inclusions such as MnS and Al₂O₃.

The area fraction of the remaining structure is preferably not more than 10%, more preferably not more than 8%, and further preferably not more than 5%. When the area fraction of the remaining structure falls within this range, the effect according to aspects of the present invention would not be impaired.

<<Amount of Diffusible Hydrogen in Steel: Not More than 0.50 Mass Ppm

When an amount of diffusible hydrogen in steel is too high, delayed fracture occurs, whereby the fracture resistance deteriorates. Hence, the amount of diffusible hydrogen in steel is not more than 0.50 mass ppm, preferably not more than 0.30 mass ppm, and more preferably not more than 0.20 mass ppm.

The amount of diffusible hydrogen in steel is determined by a method described in Examples below.

### <Plating Layer>

The present high strength steel sheet may further have a plating layer on a surface of the steel sheet for the purpose of improving corrosion resistance and other properties.

Examples of the plating layer include a galvanizing layer, a galvannealing layer and an electrogalvanizing layer. The plating layer is formed by a plating treatment described later.

### [Method of Producing High Strength Steel Sheet]

Next, a method of producing a high strength steel sheet of the present embodiment (hereinafter also referred to as “present production method”) is described. The present production method is a method of producing the present high strength steel sheet described above.

A temperature at which the steel slab, the steel sheet or the like is heated or cooled, which is described below, means a surface temperature of the steel slab, the steel sheet or the like, unless otherwise specified.

A method of producing molten steel which becomes a steel slab (steel material) is not particularly limited, and known methods using a converter, an electric furnace or the like are applicable. It is preferable to obtain a steel slab from molten steel by a continuous casting method. Another method such as an ingot casting blooming method or thin slab continuous casting may be adopted to obtain a steel slab.

### <Hot Rolling>

In the present production method, first, a steel slab having the present chemical composition described above is hot-rolled. Thus, a hot rolled steel sheet is obtained.

When the hot rolling is performed, the steel slab may be re-heated in a heating furnace and then rolled. When the steel slab maintains a temperature equal to or higher than a predetermined temperature, the steel slab may be directly rolled without being heated.

In the hot rolling, a steel slab is subjected to rough rolling and finish rolling.

Preferably, the steel slab is heated to dissolve carbides in the steel slab prior to rough rolling.

From the viewpoint of dissolving the carbides or preventing an increase in the rolling load, the temperature at the time of heating the steel slab (steel slab heating temperature) is preferably not lower than 1100° C. and more preferably not lower than 1150° C.

On the other hand, from the viewpoint of preventing an increase in scale loss, the steel slab heating temperature is preferably not higher than 1300° C. and more preferably not higher than 1280° C.

As described above, when the steel slab before the rough rolling maintains a temperature equal to or higher than a predetermined temperature and the carbides in the steel slab are dissolved, heating of the steel slab before the rough rolling can be omitted.

The conditions of the rough rolling and the finish rolling are not particularly limited, but for example, a finish rolling end temperature is preferably 700 to 1100° C., and more preferably 800 to 1000° C.

### <Cold Rolling>

Next, the hot rolled steel sheet is subjected to cold rolling, whereby a cold rolled steel sheet is obtained.

A rolling rate of the cold rolling is preferably not less than 30% and more preferably not less than 35%. The upper limit thereof is not particularly limited and is, for example, not more than 70% and preferably not more than 65%.

### <Heat Treatment>

Next, the cold rolled steel sheet obtained by the cold rolling is subjected to a heat treatment.

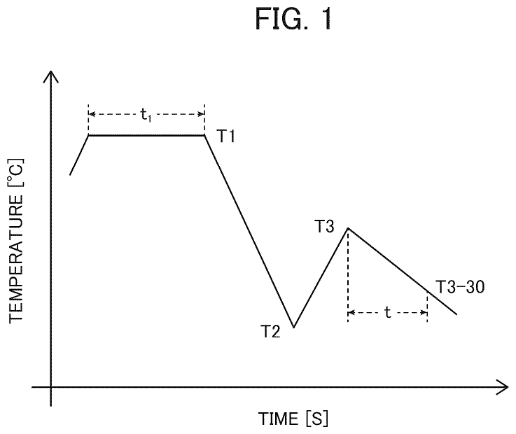

FIG. 1 is a flowchart diagram showing an example of the heat treatment.

In the heat treatment, generally speaking, the cold rolled steel sheet is heated at a heating temperature T1, cooled to a cooling stop temperature T2, then re-heated to a re-heating temperature T3, and re-cooled without being retained at the re-heating temperature T3. In the re-cooling, the cold rolled steel sheet is cooled from the re-heating temperature T3 to at least (T3−30° C.)

The cold rolled steel sheet having undergone the heat treatment corresponds to the steel sheet included in the present high strength steel sheet described above.

<<Heating Temperature T1: 750° C. To 950° C., Heating Time t₁: 10 s to 500 s>>

First, the cold rolled steel sheet is heated at the heating temperature T1.

At this time, when the heating temperature T1 is too low or when a heating time t₁ (the time for retaining the cold rolled steel sheet at the heating temperature T1) is too short, the steel sheet is heated in a dual phase region of ferrite and austenite. In this case, since the final microstructure contains ferrite and the total area fraction of tempered martensite and bainite is reduced, it is difficult to ensure good collision proof stress and yield strength.

Therefore, the heating temperature T1 is not lower than 750° C., preferably not lower than 800° C., and more preferably not lower than 850° C. The heating time t₁ is preferably not less than 10 s, preferably not less than 50 s, and more preferably not less than 80 s.

On the other hand, when the heating temperature T1 is too high, the average grain size of the retained austenite tends to be coarse, whereby the fracture resistance decreases. In addition, the amount of hydrogen entering steel increases due to an increase in a hydrogen partial pressure, whereby the amount of diffusible hydrogen in steel increases.

Further, when the heating time t₁ is too long, the average grain size of the retained austenite tends to be coarse, whereby the fracture resistance decreases.

Therefore, the heating temperature T1 is not higher than 950° C., preferably not higher than 930° C., and more preferably not higher than 900° C. The heating time t₁ is not more than 500 s, preferably not more than 300 s, and more preferably not more than 200 s.

<<Cooling Stop Temperature T2: Not Lower than 120° C. But Lower than 280° C.>>

Next, the cold rolled steel sheet having been heated at the heating temperature T1 is cooled to the cooling stop temperature T2.

When the cooling stop temperature T2 is too low, the total area fraction of tempered martensite and bainite increases, and the structure (structure S₂) having a high carbon concentration increases, whereby the fracture resistance deteriorates.

Thus, the cooling stop temperature T2 is not lower than 120° C., preferably not lower than 140° C., and more preferably not lower than 150° C.

On the other hand, when the cooling stop temperature T2 is too high, the total area fraction of tempered martensite and bainite decreases, whereby good collision proof stress and yield strength cannot be stably secured.

Therefore, the cooling stop temperature T2 is lower than 280° C., preferably not higher than 270° C., and more preferably not higher than 260° C.

### <<Re-Heating Temperature T3: 280° C. To 400° C.>>

Next, the cold rolled steel sheet having been cooled to the cooling stop temperature T2 is re-heated to the re-heating temperature T3 and is re-cooled without being retained at the re-heating temperature T3.

At this time, when the re-heating temperature T3 is too low, the structure (structure S₁) having a low carbon concentration decreases, whereby the fracture resistance deteriorates.

Therefore, the re-heating temperature T3 is not lower than 280° C., preferably not lower than 290° C., and more preferably not lower than 300° C.

On the other hand, when the re-heating temperature T3 is too high, a large amount of iron carbides precipitates in tempered martensite, the total area fraction of tempered martensite and bainite decreases, resulting in lower yield strength and lower collision proof stress.

Therefore, the re-heating temperature T3 is not higher than 400° C., preferably not higher than 380° C., and more preferably not higher than 350° C.

### <<Heat Effect Index P: 4000 to 6200>>

As described above, the cold rolled steel sheet having been re-heated to the re-heating temperature T3 is re-cooled without being retained at the re-heating temperature T3.

In the re-cooling, the cold rolled steel sheet is cooled from the re-heating temperature T3 to at least (T3−30° C.) At this time, the heat effect index P from the re-heating temperature T3 to (T3−30°) C for the cold rolled steel sheet is expressed by the following Formula (1).

P=T3(log(5t)+12) (1)

In the above Formula (1), t is the cooling time (unit: s) from the re-heating temperature T3 to (T3−30° C.)

The carbon concentration of each structure constituting the microstructure can be controlled by the heat effect index P.

In other words, in the temperature range from the re-heating temperature T3 to (T3−30°) C, solid solution carbon in martensite as a matrix phase is diffused into untransformed austenite.

When the heat effect index P is too low, solid solution carbon in martensite is not sufficiently diffused into untransformed austenite, the structure (structure S₂) having a high carbon concentration increases, and the structure (structure S₁) having a low carbon concentration decreases. Thus, the heat effect index P is not lower than 4000, preferably not lower than 4200, and more preferably not lower than 4400.

On the other hand, when the heat effect index P is too high, solid solution carbon in untransformed austenite is too large, whereby the structure (structure S₂) having a high carbon concentration increases in the final microstructure.

Accordingly, the heat effect index P is not more than 6000, preferably not more than 5800, and more preferably not more than 5500.

### <Plating Treatment>

In the present production method, the re-cooled cold rolled steel sheet may be subjected to a plating treatment to form a plating layer on the surface thereof.

Examples of the plating layer include a galvanizing layer, a galvannealing layer and an electrogalvanizing layer.

For the plating treatment, galvanizing treatment, galvannealing treatment, or electrogalvanizing treatment is preferred.

When the galvanizing treatment is performed, an apparatus configured to continuously perform the above-described heat treatment and galvanizing treatment may be used.

When the galvanizing treatment is performed, for example, the steel sheet is immersed in a zinc bath having a bath temperature of 440° C. to 500° C. to be galvanized. Thereafter, it is preferable to adjust a coating weight of the plating layer by gas wiping or other methods.

As the zinc bath, a zinc bath having a chemical composition including the Al content of 0.10 to 0.23 mass % with a balance being Zn and inevitable impurities is preferred.

When the galvannealing treatment is performed, a too low alloying temperature causes an excessively low Zn—Fe alloying rate, and this may make alloying extremely difficult. On the other hand, when the alloying temperature is too high, untransformed austenite may be transformed into pearlite. Thus, the alloying temperature is preferably 450° C. to 600° C., more preferably 470° C. to 550° C., and further preferably 470° C. to 530° C.

When the electrogalvanizing treatment is performed, an apparatus configured to be capable of successively performing the above-described heat treatment and electrogalvanizing treatment may be used.

The electrogalvanizing treatment is performed to thereby form an electrogalvanizing layer.

The types of electrogalvanizing layers are not particularly limited, and known electrogalvanizing layers are advantageously applicable. The electrogalvanizing layer may be a zinc alloy plating layer obtained by adding, to Zn, one or more of such elements as Fe, Cr, Ni, Mn, Co, Sn, Pb and Mo in suitable amounts in accordance with the intended purpose.

The coating weight of the plating layer of the galvanized steel sheet (GI), the galvannealed steel sheet (GA), or the electrogalvanized steel sheet (EG) is preferably 20 to 80 g/m² per one side (double-sided plating)

The steel sheet having undergone the plating treatment is cooled to a temperature of, for example, not higher than 50° C. The steel sheet having been cooled to a temperature of not higher than 50° C. may be subjected to rolling at an elongation rate of 0.05% to 1.00%. The elongation rate is preferably 0.08% to 0.70%.

The rolling may be performed in an apparatus that is continuous with an apparatus (plating apparatus) for performing the galvanizing treatment, or may be performed in an apparatus that is discontinuous with the plating device. In addition, the desired elongation rate may be achieved by one rolling operation, or the desired elongation rate may be achieved by performing a plurality of rolling operations in total.

Meanwhile, the rolling described here generally refers to temper rolling, but it may be rolling by processing using a leveler or the like as long as it is possible to impart an elongation rate equivalent to that achieved by temper rolling.

In the present production method, for example, the retaining temperature such as the heating temperature or the re-heating temperature need not be constant as long as it is within the above-described temperature range. A cooling rate may vary during cooling as long as it is within the above-described rate range. The heat treatment may be performed in any equipment as long as the conditions such as the above-described temperature range are satisfied.

### [Member]

Next, a member of the present embodiment (hereinafter also referred to as “present member”) is described.

The present member is a member formed by using the present high strength steel sheet described above as at least part of the member, and is, for example, a member formed into a target shape by processing (e.g., pressing) the present high strength steel sheet.

The present member is preferably a member for automotive parts. Note that the member for automotive parts may include a steel sheet other than the present high strength steel sheet as a material.

As described above, the present high strength steel sheet has a yield strength of not lower than 800 MPa and also has excellent collision proof stress and fracture resistance. Therefore, the present member is excellent in collision proof stress and fracture resistance and can contribute to reduction of the vehicle body weight, and thus is suitable for all members used in, among automotive parts, particularly skeletal structure parts or reinforcing parts of automobiles.

### [Method of Producing Member]

Next described is the method for producing the present member.

The present member is obtained by, for example, subjecting the present high strength steel sheet to at least one of a forming process and a joining process.

The forming process is not particularly limited, and examples thereof include press working.

The joining process is not particularly limited, and examples thereof include: general welding such as spot welding and arc welding; and crimping using rivets; and the like.

### EXAMPLES

Aspects of the invention are specifically described below with reference to Examples. However, the invention is not limited to the examples described below.

### <Production of Steel Sheet>

Molten steel having the chemical composition as shown in Table 1 below with the balance being Fe and inevitable impurities was made in a converter, and a steel slab was obtained by a continuous casting method. In Table 1 below, the underlined figures mean those out of the ranges of the invention (the same applies to Tables 2 to 3 to be described later).

The steel slabs thus obtained were subjected to hot rolling under the conditions described in Table 2 below, and thus hot rolled steel sheets were obtained. Specifically, each steel slab was heated to 1250° C. and rough rolled, and finish rolling was then performed at a finish rolling end temperature of 900° C.

The hot rolled steel sheet obtained was subjected to cold rolling at a rolling rate shown in Table 2 below, thereby obtaining a cold rolled steel sheet (thickness: 1.2 mm).

The cold rolled steel sheet obtained was subjected to the heat treatment under the conditions shown in Table 2 below.

In some examples, both surfaces of the cold rolled steel sheet (CR) after the heat treatment were subjected to the plating treatment to obtain a galvanized steel sheet (GI), galvannealed steel sheet (GA), or electrogalvanized steel sheet (EG).

As a galvanizing bath, when GI was produced, a zinc bath containing Al: 0.20 mass % with the balance being Zn and inevitable impurities was used, and when GA was produced, a zinc bath containing Al: 0.14 mass % with the balance being Zn and inevitable impurities was used.

The bath temperature was 470° C. for both GI and GA production.

The coating weight of the plating layer was 45 to 72 g/m² per one side when GI was produced, and 45 g/m² per one side when GA was produced.

When GA was produced, the alloying temperature was 500° C.

The composition of the plating layer of GI was a composition including Fe: 0.1 to 1.0 mass % and Al: 0.2 to 1.0 mass % with the balance being Fe and inevitable impurities. The composition of the plating layer of GA was a composition including Fe: 7 to 15 mass % and Al: 0.1 to 1.0 mass % with the balance being Fe and inevitable impurities.

When EG is produced, an electrogalvanizing treatment was performed using an electrogalvanizing line such that the resulting plating layers had a coating weight of 30 g/m² per one side.

Hereinbelow, each of the cold rolled steel sheet (CR), the galvanized steel sheet (GI), the galvannealed steel sheet (GA), and the electrogalvanized steel sheet (EG) after the heat treatment is also simply referred to as “steel sheet.”

### <Observation of Microstructure>

For each of the steel sheets thus obtained, the microstructure was observed as described below. The results are shown in Table 3 below. In Table 3 below, martensite is denoted as “M,” bainite is denoted as “B,” and austenite is denoted as “γ.”

### <<Total Area Fraction of Tempered Martensite and Bainite>>

The obtained steel sheet was polished such that a cross section (L cross section) at a position of ¼ of the sheet thickness and parallel to the rolling direction became an observation surface. The observation surface was etched using 1 vol % Nital, and then enlarged and observed with a scanning electron microscope (SEM) at a magnification of 3,000×.

The observation surface was observed in 10 fields, and SEM images were obtained. The obtained SEM images were analyzed to determine the total area fraction (unit: %) of tempered martensite and bainite.

More specifically, dark gray parts in each obtained SEM image were determined to be tempered martensite and bainite, and the area fraction (average area fraction of the 10 fields) was determined. For the SEM image analysis, Image-Pro available from Media Cybernetics Inc. was used as analysis software.

### <<Average Grain Size in Retained Austenite>>

The obtained steel sheet was subjected to buffing using a colloidal silica solution after grinding such that a cross section (L cross section) parallel to the rolling direction became an observation surface. Thereafter, 10 regions of 50 μm×50 μm on the observation surface were measured by the EBSD method (electron beam accelerating voltage: 15 kV, step interval: 0.04 μm), and data for obtaining structure images was obtained. The obtained data was processed using OIM Analysis software available from TSL Co. to obtain structure images. With the obtained structure images, the areas of the retained austenitic crystal grains were determined using Image-Pro available from Media Cybernetics Inc., and the circle equivalent diameters thereof were calculated. An average of these values was defined as the average grain size (unit: μm) of retained austenite.

<<Area Fraction of Structure S₁ and Structure S₂>>

The obtained steel sheet was polished using a diamond paste such that a cross section (L cross section) parallel to the rolling direction became an observation surface. The observation surface was finished to a mirror surface by alumina polishing, and then cleaned using a plasma cleaner in order to eliminate contamination of hydrocarbons (carbon contamination, hereinafter referred to as “contamination”) on the observation surface.

The cleaned observation surface was measured using an electron beam microanalyzer (FE-EPMA: Field Emission Electron Probe Micro Analyzer) equipped with a field emission electron gun to obtain data for obtaining elemental mapping images. In accordance with Non-Patent Literature (T. Yamashita, Y. Tanaka, M. Nagoshi and K. Ishida: Sci. Rep., 6 (2016), DOI: 10.1038/srep29825.), the measurement conditions were an acceleration voltage of 7 kV and an electric current of 50 nA. At this time, the steel sheet as a sample was heated and retained at 100° C. and measured under conditions which do not allow contamination to be present. The data after the measurement was converted to carbon concentration by a calibration method, and an elemental mapping image of carbon was obtained.

For each steel sheet, the measurement with the FE-EPMA was performed 30 times, and an elemental mapping image was obtained each time.

With respect to the whole area of the obtained elemental mapping image, a ratio of a region (area fraction) in which a carbon concentration was more than 0.1 mass % and not more than 0.3 mass % was determined, the average value of 30 measurements was defined as the area fraction (unit: %) of the structure S₁.

Similarly, with respect to the whole area of the obtained elemental mapping image, the ratio of a region (area fraction) where a carbon concentration was not less than 0.5 mass % was determined, and the average value of 30 measurements was defined as the area fraction (unit: %) of the structure S₂.

### <Measurement of Amount of Diffusible Hydrogen in Steel>

A specimen having a length of 30 mm and a width of 5 mm was sampled from the obtained steel sheet. For the sampled specimen, the amount of diffusible hydrogen in steel was measured by the thermal desorption analytical method. The heating rate was 200° C./hr. The cumulative value of the amount of hydrogen detected in the temperature range from room temperature (25° C.) to a temperature lower than 210° C. was defined as the amount of diffusible hydrogen in steel (unit: mass ppm).

The steel sheet on which the plating layer had been formed was measured in the same manner after the plating layer was removed using a router (precision grinder).

The result is shown in Table 3 below. The amount of diffusible hydrogen in steel is preferably not more than 0.50 mass ppm.

### <Evaluation>

The obtained steel sheets were evaluated by the following methods. The results are shown in Table 3 below.

### <<Tensile Test>>

From each of the obtained steel sheets, No. 5 specimen described in JIS Z 2241 with its longitudinal direction (tensile direction) being a direction of 90° to the rolling direction was sampled. Using the specimen thus sampled, a tensile test according to JIS Z 2241 was performed 5 times, and the yield strength (YS) was determined from the average value of 5 tests.

When the YS was not less than 800 MPa, the strength can be determined to be high.

### <<Collision Proof Stress Evaluation Test>>

Using each of the obtained steel sheets, a member (hat member) having a hat-shaped cross section was produced, and a three-point bending test was performed to determine the maximum load (unit: kN).

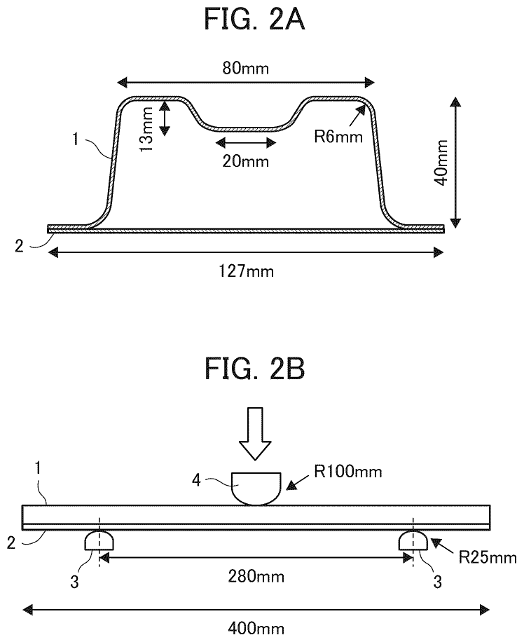

First, a hat member 1 is described with reference to FIG. 2A.

FIG. 2A is a cross-sectional view showing the hat member 1. In FIG. 2A, the dimensions of the hat member 1 are shown. The hat member 1 is joined to a flat plate 2 by spot welding (nugget diameter: 4.5√t, spot-to-spot pitch: 35 mm). The flat plate 2 is a cold-rolled steel sheet having no plating layer, and has a tensile strength (TS) of 590 MPa and a thickness t that is the same (1.2 mm) as that of the hat member 1.

Next, the three-point bending test is described with reference to FIG. 2B.

FIG. 2B is a schematic view showing the hat member 1 subjected to the three-point bending test. Various dimensions are shown also in FIG. 2B. The flat plate 2 joined to the hat member 1 is supported by a support member 3 which is a rigid body. In this state, an impactor 4, which is a rigid body, is moved from above toward the hat member 1 at a velocity of 1 m/s. In this way, the three-point bending test is performed.

For each steel sheet, the three-point bending test was performed three times, and the average value of the maximum loads obtained in respective tests was defined as the maximum load of the steel sheet.

When the maximum load was not less than 40 kN, “A” was given, when the maximum load was not less than 30 kN and less than 40 kN, “B” was given, and when the maximum load was less than 30 kN, “C” was given in Table 3 below.

When the result is A or B, the collision proof stress can be rated as excellent.

### <<Fracture Resistance Evaluation Test>>

From each of the obtained steel sheets, a test piece (length of parallel portion: 40 mm, width of parallel portion: 20 mm) whose longitudinal direction (tensile direction) was 90° with respect to the rolling direction was cut out in accordance with JIS Z 2241. A machined hole having a diameter of 8 mm was formed at a central position in the longitudinal direction of the parallel portion and at a center position in the width direction of the parallel portion in the test piece.

A tensile test with a constant tensile rate (2 mm/min) was performed 5 times in accordance with JIS Z 2241 using the specimen in which the machined hole was formed, and a fracture stroke was determined.

When the fracture stroke (average value of 5 tensile tests) was not less than 0.85 mm, “A” was given, when the fracture stroke was not less than 0.70 mm and less than 0.85 mm, “B” was given below, and when the fracture stroke is less than 0.70 mm, “C” was given in Table 3 below.

When the result is A or B, the fracture resistance can be rated as excellent.

TABLE 1

| Steel | Chemical composition [mass %] | | | | | | | | | | | | | | |
|---|---|---|---|---|---|---|---|---|---|---|---|---|---|---|---|
| ID | C | Si | Mn | P | S | Al | N | O | B | Ti | Nb | V | W | Mo | Cr |
| A | 0.234 | 1.23 | 2.82 | 0.006 | 0.0005 | 0.041 | 0.0040 | 0.0006 | 0.0019 | 0.021 | 0.020 | — | — | — | — |
| B | 0.322 | 1.52 | 3.08 | 0.004 | 0.0008 | 0.036 | 0.0041 | 0.0007 | — | — | 0.018 | — | — | — | — |
| C | 0.242 | 1.31 | 2.95 | 0.005 | 0.0010 | 0.040 | 0.0039 | 0.0006 | — | — | — | 0.090 | — | — | — |
| D | 0.153 | 1.52 | 3.50 | 0.010 | 0.0010 | 0.052 | 0.0042 | 0.0008 | — | — | — | — | 0.025 | — | — |
| E | 0.288 | 2.91 | 1.65 | 0.009 | 0.0015 | 0.045 | 0.0048 | 0.0012 | — | — | 0.046 | — | — | 0.198 | — |
| F | 0.248 | 1.36 | 2.79 | 0.011 | 0.0011 | 0.042 | 0.0051 | 0.0004 | 0.0046 | 0.020 | — | — | — | — | — |
| G | 0.275 | 1.45 | 2.35 | 0.004 | 0.0007 | 0.031 | 0.0061 | 0.0006 | — | — | — | — | — | — | — |
| H | 0.223 | 1.05 | 1.43 | 0.012 | 0.0019 | 0.029 | 0.0035 | 0.0007 | — | — | — | 0.022 | — | — | — |
| I | 0.191 | 1.45 | 4.02 | 0.010 | 0.0020 | 0.041 | 0.0041 | 0.0010 | — | — | 0.035 | — | — | — | — |
| J | 0.502 | 1.25 | 2.23 | 0.006 | 0.0015 | 0.036 | 0.0038 | 0.0020 | — | — | — | — | — | — | — |
| K | 0.141 | 1.15 | 3.10 | 0.007 | 0.0012 | 0.055 | 0.0059 | 0.0060 | — | — | — | — | — | — | — |
| L | 0.270 | 1.72 | 2.41 | 0.013 | 0.0009 | 0.039 | 0.0035 | 0.0006 | — | — | — | — | — | — | 0.220 |
| M | 0.261 | 3.20 | 2.64 | 0.015 | 0.0015 | 0.032 | 0.0051 | 0.0050 | — | — | — | — | — | — | — |
| N | 0.262 | 0.004 | 2.52 | 0.018 | 0.0015 | 0.058 | 0.0034 | 0.0030 | — | — | — | — | — | — | — |
| O | 0.321 | 1.62 | 2.75 | 0.008 | 0.0009 | 0.032 | 0.0041 | 0.0004 | — | — | — | — | — | — | — |
| P | 0.241 | 1.39 | 2.65 | 0.006 | 0.0009 | 0.041 | 0.0038 | 0.0006 | — | — | — | — | — | — | — |
| Q | 0.261 | 1.28 | 2.79 | 0.009 | 0.0009 | 0.054 | 0.0042 | 0.0006 | — | — | — | — | — | — | — |
| R | 0.254 | 1.26 | 2.85 | 0.010 | 0.0009 | 0.042 | 0.0051 | 0.0006 | — | — | — | — | — | — | — |
| S | 0.235 | 1.35 | 2.72 | 0.005 | 0.0009 | 0.053 | 0.0034 | 0.0006 | — | 0.091 | — | — | — | — | — |
| T | 0.223 | 0.02 | 2.87 | 0.015 | 0.0016 | 0.029 | 0.0052 | 0.0015 | — | — | — | — | — | — | — |
| U | 0.225 | 2.76 | 2.65 | 0.016 | 0.0014 | 0.091 | 0.0041 | 0.0016 | — | — | — | — | — | — | — |
| V | 0.311 | 0.42 | 2.65 | 0.012 | 0.0011 | 0.041 | 0.0092 | 0.0004 | — | — | — | — | — | — | — |
| W | 0.238 | 1.26 | 3.52 | 0.010 | 0.0020 | 0.059 | 0.0038 | 0.0006 | — | — | — | — | — | — | — |
| X | 0.238 | 1.32 | 1.81 | 0.015 | 0.0016 | 0.049 | 0.0025 | 0.0004 | — | — | — | — | — | — | — |

| Steel | Chemical composition [mass %] | | | | | | | | | | | | |
|---|---|---|---|---|---|---|---|---|---|---|---|---|---|
| ID | Sb | Sn | Zr | Cu | Ni | Ca | Mg | Co | Ta | REM | Hf | Te | Bi |
| A | — | — | — | — | — | — | — | — | — | — | — | — | — |
| B | 0.007 | — | — | — | — | — | — | — | — | — | — | — | — |
| C | — | — | | — | — | — | — | — | — | — | — | — | — |
| D | — | — | — | — | — | — | — | — | — | — | — | — | — |
| E | — | — | — | — | — | — | — | — | — | — | — | — | — |
| F | — | — | — | 0.120 | — | — | — | — | — | — | — | — | — |
| G | — | — | — | — | — | — | — | — | — | — | — | — | — |
| H | — | — | — | — | — | — | — | — | — | — | — | — | — |
| I | — | — | — | — | — | — | — | — | — | — | — | — | — |
| J | — | — | — | — | — | — | — | — | — | — | — | — | — |
| K | — | — | — | — | — | — | — | — | — | — | — | — | — |
| L | 0.015 | — | — | — | — | — | — | — | — | — | — | — | — |
| M | — | — | — | — | — | — | — | — | — | — | — | — | — |
| N | — | — | — | — | — | — | — | — | — | — | — | — | — |
| O | — | 0.010 | 0.0220 | — | — | — | — | — | — | — | — | — | — |
| P | — | — | — | 0.220 | 0.125 | — | — | — | — | — | — | — | — |
| Q | — | — | — | — | — | 0.0012 | 0.0020 | — | — | — | — | — | — |
| R | — | — | — | — | — | — | — | 0.005 | — | — | — | — | — |
| S | — | — | — | — | — | — | — | — | 0.03 | 0.0010 | — | — | — |
| T | — | — | — | — | — | — | — | — | — | — | 0.03 | 0.005 | — |
| U | — | — | — | — | — | — | — | — | — | — | — | — | — |
| V | — | — | — | — | — | — | — | — | — | — | — | — | — |
| W | — | — | — | 0.360 | — | — | — | — | — | — | — | — | 0.013 |
| X | — | — | — | — | — | — | — | — | — | — | — | — | 0.004 |

TABLE 2

| | | Hot rolling | | Cold | | | |
|---|---|---|---|---|---|---|---|
| | | Steel slab | Finish | rolling | Heat treatment | | |
| | | heating | rolling end | Rolling | Heating | Heating | Cooling stop |
| | Steel | temperature | temperature | rate | temperature | time | temperature |
| No. | ID | [°C] | [°C] | [%] | T1 [°C] | t₁ [s] | T2 [°C] |
| 1 | A | 1250 | 900 | 45 | 875 | 130 | 200 |
| 2 | A | 1250 | 900 | 46 | 875 | 130 | 200 |
| 3 | A | 1250 | 900 | 45 | 875 | 130 | 180 |
| 4 | A | 1250 | 900 | 45 | 875 | 130 | 210 |
| 5 | A | 1250 | 900 | 45 | 870 | 120 | 150 |
| 6 | B | 1250 | 900 | 50 | 880 | 120 | 200 |
| 7 | B | 1250 | 900 | 50 | 880 | 120 | 150 |
| 8 | B | 1250 | 900 | 50 | 880 | 110 | 200 |
| 9 | B | 1250 | 900 | 45 | 880 | 110 | 180 |
| 10 | C | 1250 | 900 | 45 | 870 | 100 | 190 |
| 11 | C | 1250 | 900 | 45 | 965 | 100 | 200 |
| 12 | C | 1250 | 900 | 45 | 730 | 100 | 200 |
| 13 | C | 1250 | 900 | 45 | 870 | 100 | 110 |
| 14 | C | 1250 | 900 | 45 | 870 | 100 | 300 |
| 15 | D | 1250 | 900 | 50 | 880 | 150 | 280 |
| 16 | E | 1250 | 900 | 50 | 880 | 120 | 200 |
| 17 | F | 1250 | 900 | 50 | 880 | 150 | 200 |
| 18 | F | 1250 | 900 | 50 | 880 | 8 | 200 |
| 19 | F | 1250 | 900 | 50 | 880 | 520 | 200 |
| 20 | F | 1250 | 900 | 50 | 880 | 150 | 200 |
| 21 | F | 1250 | 900 | 50 | 880 | 150 | 200 |
| 22 | G | 1250 | 900 | 50 | 880 | 150 | 190 |
| 23 | G | 1250 | 900 | 50 | 880 | 150 | 190 |
| 24 | G | 1250 | 900 | 50 | 880 | 150 | 190 |
| 25 | G | 1250 | 900 | 50 | 880 | 150 | 200 |
| 26 | H | 1250 | 900 | 45 | 870 | 110 | 200 |
| 27 | I | 1250 | 900 | 50 | 880 | 150 | 275 |
| 28 | J | 1250 | 900 | 45 | 870 | 110 | 200 |
| 29 | K | 1250 | 900 | 50 | 880 | 150 | 270 |
| 30 | L | 1250 | 900 | 50 | 880 | 150 | 200 |
| 31 | M | 1250 | 900 | 50 | 880 | 150 | 210 |
| 32 | N | 1250 | 900 | 50 | 880 | 150 | 210 |
| 33 | O | 1250 | 900 | 50 | 865 | 390 | 210 |
| 34 | P | 1250 | 900 | 45 | 870 | 100 | 220 |
| 35 | Q | 1250 | 900 | 50 | 880 | 150 | 220 |
| 36 | R | 1250 | 900 | 50 | 880 | 60 | 140 |
| 37 | S | 1250 | 900 | 50 | 880 | 150 | 200 |
| 38 | T | 1250 | 900 | 50 | 880 | 150 | 220 |
| 39 | U | 1250 | 900 | 45 | 870 | 100 | 220 |
| 40 | V | 1250 | 900 | 45 | 870 | 100 | 160 |
| 41 | W | 1250 | 900 | 45 | 870 | 110 | 200 |
| 42 | X | 1250 | 900 | 45 | 870 | 110 | 200 |

| | Heat treatment | | | | |
|---|---|---|---|---|---|
| | | Cooling time | Heat | | |
| | Re-heating | t from T3 to | effect | | |
| | temperature | (T3-30)°C | index | Plating | |
| No. | T3 [°C] | [s] | P | treatment | Remarks |
| 1 | 320 | 240 | 4825 | CR | Compatible steel |
| 2 | 340 | 250 | 5133 | CR | Compatible steel |
| 3 | 330 | 200 | 4950 | GA | Compatible steel |
| 4 | 310 | 390 | 4740 | CR | Compatible steel |
| 5 | 320 | 200 | 4800 | CR | Compatible steel |
| 6 | 370 | 180 | 5533 | CR | Compatible steel |
| 7 | 350 | 150 | 5206 | CR | Compatible steel |
| 8 | 350 | 100 | 5145 | EG | Compatible steel |
| 9 | 350 | 320 | 5321 | CR | Compatible steel |
| 10 | 330 | 200 | 4950 | CR | Compatible steel |
| 11 | 320 | 200 | 4800 | GA | Comparative steel |
| 12 | 320 | 250 | 4831 | EG | Comparative steel |
| 13 | 300 | 200 | 4500 | CR | Comparative steel |
| 14 | 360 | 200 | 5400 | CR | Comparative steel |
| 15 | 350 | 250 | 5284 | CR | Compatible steel |
| 16 | 360 | 220 | 5415 | GI | Compatible steel |
| 17 | 340 | 230 | 5121 | CR | Compatible steel |
| 18 | 330 | 250 | 4982 | CR | Comparative steel |
| 19 | 330 | 250 | 4982 | CR | Comparative steel |
| 20 | 280 | 30 | 3969 | GA | Comparative steel |
| 21 | 398 | 780 | 6205 | CR | Comparative steel |
| 22 | 350 | 190 | 5242 | CR | Compatible steel |
| 23 | 260 | 190 | 3894 | GA | Comparative steel |
| 24 | 420 | 190 | 6291 | CR | Comparative steel |
| 25 | 340 | 300 | 5160 | CR | Compatible steel |
| 26 | 320 | 220 | 4813 | CR | Comparative steel |
| 27 | 370 | 50 | 5327 | CR | Comparative steel |
| 28 | 320 | 400 | 4896 | CR | Comparative steel |
| 29 | 380 | 50 | 5471 | CR | Comparative steel |
| 30 | 330 | 250 | 4982 | CR | Compatible steel |
| 31 | 330 | 250 | 4982 | CR | Comparative steel |
| 32 | 330 | 250 | 4982 | CR | Comparative steel |
| 33 | 340 | 200 | 5100 | GA | Compatible steel |
| 34 | 300 | 200 | 4500 | GA | Compatible steel |
| 35 | 330 | 200 | 4950 | GA | Compatible steel |
| 36 | 290 | 180 | 4337 | GA | Compatible steel |
| 37 | 300 | 200 | 4500 | GI | Compatible steel |
| 38 | 360 | 150 | 5355 | CR | Compatible steel |
| 39 | 300 | 200 | 4500 | GI | Compatible steel |
| 40 | 300 | 200 | 4500 | EG | Compatible steel |
| 41 | 320 | 220 | 4813 | CR | Compatible steel |
| 42 | 320 | 220 | 4813 | CR | Compatible steel |

TABLE 3

| | Microstructure | | | | Amount of | | | | |
|---|---|---|---|---|---|---|---|---|---|
| | Total area | Average | Area | Area | diffusible | | | | |
| | fraction | grain size | fraction of | fraction of | hydrogen | | Collision | | |
| | of tempered | of retained | structure | structure | in steel | YS | proof | Fracture | |
| No. | M and B [%] | γ [μm] | S₁ [%] | S₂ [%] | [mass ppm] | [MPa] | stress | resistance | Remarks |
| 1 | 83 | 0.6 | 70.3 | 2.1 | 0.00 | 1135 | A | A | Compatible steel |
| 2 | 88 | 0.5 | 72.1 | 2.5 | 0.00 | 1170 | A | A | Compatible steel |
| 3 | 70 | 0.4 | 65.5 | 3.4 | 0.19 | 1250 | A | A | Compatible steel |
| 4 | 85 | 0.8 | 65.2 | 2.6 | 0.00 | 1140 | A | A | Compatible steel |
| 5 | 55 | 0.5 | 62.4 | 4.2 | 0.00 | 1220 | B | A | Compatible steel |
| 6 | 90 | 0.9 | 60.1 | 5.5 | 0.00 | 1300 | A | A | Compatible steel |
| 7 | 93 | 0.9 | 65.2 | 6.2 | 0.00 | 1350 | A | A | Compatible steel |
| 8 | 88 | 0.9 | 58.5 | 6.1 | 0.00 | 1280 | A | A | Compatible steel |
| 9 | 82 | 0.8 | 55.3 | 6.8 | 0.00 | 1320 | A | A | Compatible steel |
| 10 | 85 | 0.6 | 72.2 | 3.5 | 0.00 | 1250 | A | A | Compatible steel |
| 11 | 86 | 8.3 | 68.7 | 4.0 | 0.66 | 1210 | A | C | Comparative steel |
| 12 | 43 | 0.7 | 64.9 | 5.1 | 0.25 | 770 | C | A | Comparative steel |
| 13 | 96 | 0.8 | 68.3 | 13.6 | 0.00 | 1300 | B | C | Comparative steel |
| 14 | 42 | 0.9 | 60.5 | 4.6 | 0.00 | 780 | C | A | Comparative steel |
| 15 | 56 | 0.8 | 65.1 | 2.1 | 0.01 | 850 | B | B | Compatible steel |
| 16 | 60 | 0.8 | 55.2 | 9.2 | 0.01 | 880 | B | B | Compatible steel |
| 17 | 85 | 0.7 | 62.4 | 1.8 | 0.00 | 1330 | A | A | Compatible steel |
| 18 | 45 | 0.8 | 60.8 | 6.2 | 0.01 | 770 | C | A | Comparative steel |
| 19 | 80 | 7.5 | 58.2 | 5.1 | 0.01 | 1280 | A | C | Comparative steel |
| 20 | 80 | 0.7 | 40.1 | 13.5 | 0.00 | 1280 | A | C | Comparative steel |
| 21 | 82 | 0.7 | 60.5 | 11.5 | 0.01 | 1290 | A | C | Comparative steel |
| 22 | 88 | 0.8 | 75.7 | 2.6 | 0.00 | 1390 | A | A | Compatible steel |
| 23 | 90 | 0.8 | 45.2 | 12.5 | 0.40 | 1290 | A | C | Comparative steel |
| 24 | 52 | 0.7 | 52.2 | 14.2 | 0.00 | 790 | C | C | Comparative steel |
| 25 | 84 | 0.8 | 74.3 | 3.2 | 0.00 | 1350 | A | A | Compatible steel |
| 26 | 52 | 0.7 | 65.9 | 5.1 | 0.01 | 750 | C | A | Comparative steel |
| 27 | 97 | 0.9 | 52.2 | 12.0 | 0.01 | 850 | A | C | Comparative steel |
| 28 | 93 | 0.9 | 51.7 | 13.5 | 0.01 | 1540 | A | C | Comparative steel |
| 29 | 43 | 0.8 | 52.2 | 2.4 | 0.01 | 750 | C | A | Comparative steel |
| 30 | 78 | 0.6 | 70.1 | 4.1 | 0.00 | 1150 | A | A | Compatible steel |
| 31 | 70 | 0.8 | 55.9 | 11.6 | 0.01 | 1220 | A | C | Comparative steel |
| 32 | 52 | 0.8 | 60.5 | 3.2 | 0.01 | 780 | C | A | Comparative steel |
| 33 | 88 | 0.8 | 62.3 | 6.3 | 0.15 | 1250 | A | A | Compatible steel |
| 34 | 81 | 0.6 | 70.8 | 3.6 | 0.11 | 1260 | A | A | Compatible steel |
| 35 | 82 | 0.8 | 72.6 | 4.3 | 0.12 | 1320 | A | A | Compatible steel |
| 36 | 62 | 0.6 | 65.5 | 5.6 | 0.12 | 980 | A | A | Compatible steel |
| 37 | 82 | 0.6 | 68.1 | 4.3 | 0.00 | 1120 | A | A | Compatible steel |
| 38 | 56 | 0.6 | 55.3 | 4.1 | 0.00 | 1050 | B | A | Compatible steel |
| 39 | 80 | 0.7 | 60.6 | 9.2 | 0.00 | 1120 | A | B | Compatible steel |
| 40 | 88 | 0.8 | 61.3 | 6.5 | 0.00 | 1210 | B | A | Compatible steel |
| 41 | 89 | 0.7 | 68.9 | 3.9 | 0.00 | 1140 | A | B | Compatible steel |
| 42 | 65 | 0.7 | 65.5 | 3.6 | 0.00 | 850 | B | A | Compatible steel |

### <Summary of Evaluation Results>

As shown in Tables 1 to 3 above, the steel sheets of Nos. 1 to 10, 15 to 17, 22, 25, 30, and 33 to 42 all had yield strengths of not less than 800 MPa and were excellent in collision proof stress and fracture resistance.

In contrast, in the steel sheet of each of Nos. 11 to 14, 18 to 21, 23, 24, 26 to 29, 31 and 32, at least one of the yield strength, the collision proof stress and the fracture resistance was insufficient.

1. A high strength steel sheet comprising a steel sheet,
wherein an amount of diffusible hydrogen in steel of the steel sheet is not more than 0.50 mass ppm,
the steel sheet has chemical composition and microstructure,
the chemical composition including, by mass:
C in an amount of 0.150 to 0.500%,
Si in an amount of 0.01 to 3.00%,
Mn in an amount of 1.50 to 4.00%,
P in an amount of not more than 0.100%,
S in an amount of not more than 0.0200%,
Al in an amount of not more than 0.100%,
N in an amount of not more than 0.0100%, and
O in an amount of not more than 0.0100%, with a balance being Fe and inevitable impurities,
in the microstructure,
a total area fraction of tempered martensite and bainite is 55% to 95%,
an average grain size of retained austenite is not more than 5.0 μm, and
an area fraction of a structure S₁ having a carbon concentration of more than 0.1 mass % and not more than 0.3 mass % is not less than 50.0%, and an area fraction of a structure S₂ having a carbon concentration of not more than 0.5 mass % is not more than 10.0%.

2. The high strength steel sheet according to claim 1, wherein the chemical composition further includes at least one element selected from the group consisting of: by mass,
B in an amount of not more than 0.0100%,
Ti in an amount of not more than 0.200%,
Nb in an amount of not more than 0.200%,
V in an amount of not more than 0.200%,
W in an amount of not more than 0.100%,
Mo in an amount of not more than 1.000%,
Cr in an amount of not more than 1.000%,
Sb in an amount of not more than 0.200%,
Sn in an amount of not more than 0.200%,
Zr in an amount of not more than 0.1000%,
Te in an amount of not more than 0.100%,
Cu in an amount of not more than 1.000%,
Ni in an amount of not more than 1.000%,
Ca in an amount of not more than 0.0100%,
Mg in an amount of not more than 0.0100%,
REM in an amount of not more than 0.0100%,
Co in an amount of not more than 0.010%,
Ta in an amount of not more than 0.10%,
Hf in an amount of not more than 0.10%, and
Bi: in an amount of not more than 0.200%.

3. The high strength steel sheet according to claim 1, wherein a plating layer is further provided on a surface of the steel sheet.

4. The high strength steel sheet according to claim 3, wherein the plating layer is a galvanizing layer, a galvannealing layer or an electrogalvanizing layer.

5. A method of producing the high strength steel sheet according to claim 1, the method comprising:
subjecting a steel slab having the chemical composition to hot rolling to obtain a hot rolled steel sheet;
subjecting the hot rolled steel sheet to cold rolling to obtain a cold rolled steel sheet; and
heating the cold rolled steel sheet at a heating temperature T1 of 750° C. to 950° C. for 10 s to 500 s, cooling the heated cold rolled steel sheet to a cooling stop temperature T2 of not lower than 120° C. and lower than 280° C., re-heating the cooled cold rolled steel sheet to a re-heating temperature T3 of 280 to 400° C., and re-cooling the re-heated cold rolled steel sheet without retaining the re-heated cold rolled steel sheet at the re-heating temperature T3,
wherein a heat effect index P from the re-heating temperature T3 to (T3−30°) C is 4000 to 6200, the heat effect index P being expressed by Formula (1),
P=T3(log(5t)+12) (1)
in Formula (1), t is a cooling time from the re-heating temperature T3 to (T3−30°) C, and a unit thereof is second.

6. A method of producing the high strength steel sheet according to claim 2, the method comprising:
subjecting a steel slab having the chemical composition to hot rolling to obtain a hot rolled steel sheet;
subjecting the hot rolled steel sheet to cold rolling to obtain a cold rolled steel sheet; and
heating the cold rolled steel sheet at a heating temperature T1 of 750° C. to 950° C. for 10 s to 500 s, cooling the heated cold rolled steel sheet to a cooling stop temperature T2 of not lower than 120° C. and lower than 280° C., re-heating the cooled cold rolled steel sheet to a re-heating temperature T3 of 280 to 400° C., and re-cooling the re-heated cold rolled steel sheet without retaining the re-heated cold rolled steel sheet at the re-heating temperature T3,
wherein a heat effect index P from the re-heating temperature T3 to (T3−30°) C is 4000 to 6200, the heat effect index P being expressed by the Formula (1),
P=T3(log(5t)+12) (1)
in Formula (1), t is a cooling time from the re-heating temperature T3 to (T3−30°) C, and a unit thereof is second.

7. The method of producing the high strength steel sheet according to claim 5, wherein the cold rolled steel sheet is subjected to a plating treatment.

8. The method of producing the high strength steel sheet according to claim 7, wherein the plating treatment is a galvanizing treatment, a galvannealing treatment, or an electrogalvanizing treatment.

9. A member obtained by using the high strength steel sheet according to claim 1.

10. A method of producing a member, the method comprising subjecting the high strength steel sheet according to claim 1 to at least one of a forming process and a joining process to obtain a member.

11. The high strength steel sheet according to claim 2, wherein a plating layer is further provided on a surface of the steel sheet.

12. The high strength steel sheet according to claim 11, wherein the plating layer is a galvanizing layer, a galvannealing layer or an electrogalvanizing layer.

13. The method of producing the high strength steel sheet according to claim 6, wherein the cold rolled steel sheet is subjected to a plating treatment.

14. The method of producing the high strength steel sheet according to claim 13, wherein the plating treatment is a galvanizing treatment, a galvannealing treatment, or an electrogalvanizing treatment.

15. A member obtained by using the high strength steel sheet according to claim 2.

16. A member obtained by using the high strength steel sheet according to claim 3.

17. A member obtained by using the high strength steel sheet according to claim 4.

18. A member obtained by using the high strength steel sheet according to claim 11.

19. A member obtained by using the high strength steel sheet according to claim 12.

20. A method of producing a member, the method comprising subjecting the high strength steel sheet according to claim 2 to at least one of a forming process and a joining process to obtain a member.
